(19) United States
(12) Patent Application Publication
(10) Pub. No.: US 2004/0144721 A1
(43) Pub. Date: Jul. 29, 2004

(54) Process for the removal of organic pollutants from sediments

(76) Inventors: Edoardo D'Angeli, Rome (IT); Alessandro Nardella, Rome (IT); Rosario Pappa, Rome (IT); Raffaello Sisto, Rome (IT)

Correspondence Address: Oblon Spivak McClelland, Maier & Neustadt, Fourth Floor, 1755 Jefferson Davis Highway, Arlington, VA, 22202, US

(21) Appl. No.: 10/476,656

(22) PCT Filed: Apr. 25, 2002
(86) PCT No.: PCT/EP02/04579

(30) Foreign Application Priority Data
May 10, 2001 (IT) MI2001A000956

(51) Int. Cl. B01D 11/00

(52) U.S. Cl. 210/634; 210/774; 210/787; 210/806

(57) ABSTRACT

A process is described for the removal of organic pollutants from sediments characterized by a water content ranging from 5% to the saturation of the sediment and with a prevalently fine particle-size content (<63 μm), which uses, as extractant, a lipophile solvent or a mixture thereof with a hydrophile cosolvent.

The present invention relates to a remediation process of sediments polluted by organic compounds.

More specifically, the present invention relates to a process for the removal of organic pollutants from sediments characterized by a water content ranging from 5% to the saturation of the sediment and with a prevalently fine particle-size content (<63 μm), which uses, as extractant, a lipophile solvent or a mixture thereof with a hydrophile cosolvent.

The continuous dredging of harbour and lagoon areas, indispensable for maintaining the navigability of waterways and for preventing flooding-due to the silting up of river mouths, causes a production of sediments, most of which are contaminated by industrial and civil waste, navigation and port activities.

According to the regulations in force, the resulting material can be discharged into the open sea, used as fillers, if inert, or, if classified as dangerous, it must be disposed of in dumps.

In order to satisfy the demand for reducing the use of dumps, in more advanced countries (USA and Northern Europe) the development of on-site or ex situ treatment processes which declassify contaminated sediments to inert products and in some cases provide for their distribution, is continually growing.

The technologies generally adopted for the treatment of sediments are: soil washing, bioremediation and solidification/stabilization.

The term soil-washing refers to washing techniques which use water, optionally containing surfactants.

Soil washing exploits the tendency of pollutants to bind themselves, either chemically or physically, to the finer particles of the sediment. These particles can be separated from the rest of the matrix by means of a more or less complex series of separation operations based on differences in dimensions, density and surface properties. With this technology the separation is obtained of a fine polluted fraction and a coarse decontaminated fraction.

The finer particles thus separated, only represent a small fraction of the initial polluted volume, but contain most of the pollutants.

Soil washing is an emerging technology adopted in numerous harbour situations in Northern Europe (Rotterdam, Hamburg) for reducing the quantity of toxic material to be deposited in dumps and recovering part of the treatment costs by the selling of the coarser fraction produced as building material.

This process however has substantial disadvantages deriving from the necessity of operating with large volumes of extracting agent and the difficulty of recovering the additives used.

Furthermore, these techniques are difficult to apply to matrixes with a prevalently fine particle-size (<63 μm).

Biological remediation techniques are limited to biodegradable compounds and non-toxic concentrations and are greatly jeopardized by the long times necessary for completing the remediation.

Solidification/stabilization processes consist in adding a hydraulic ligand to the sediment, for example Portland cement. In this way the pollutants are physically blocked inside the cementitious matrix and can no longer migrate into the surrounding environment.

In some processes, in addition to cement, specific additives are added, capable of reacting with the pollutants transforming them into less toxic or less mobile species.

This type of technology has the disadvantage of producing an increase in the volume of the material treated (sediment+ligand) and, in any case, does not guarantee the stability of the end-product over a period of time.

Treatment processes based on extraction with a solvent selected, for example, from methylene chloride, liquefied C₂-C₄ hydrocarbons, or supercritical fluids, are also known in the art.

The applicability and efficiency of these processes however is greatly limited by the presence of high percentages of fine particles and by the high water content which generally characterize the sediments.

It has now been found that it is possible to overcome the drawbacks mentioned above by means of a process which uses, as extractant, a lipophile solvent or a mixture thereof with a hydrophile cosolvent.

The use of the lipophile solvent alone allows high removal efficiencies to be obtained, regardless of the content of water and fine particles present in the sediment, thanks to the fact that the fine particles remain aggregated among each other. The liquid-solid separation therefore takes place by simple sedimentation.

The use of the solvent/cosolvent mixture allows the organic contaminants to be removed with the formation of a solid-liquid suspension which can be easily pumped.

In accordance with this, an objective of the present invention relates to a process for the removal of organic pollutants from sediments characterized by a water content ranging from 5% to the saturation of the sediment and with a prevalently fine particle-size content (<63 μm), comprising the following steps:

(a) mixing of said sediment with a lipophile solvent or with a mixture consisting of a lipophile solvent and a hydrophile cosolvent, said solvent and cosolvent being selected and mixed with each other in such a ratio as to form a single liquid phase with the water contained in the sediment;

(b) separation of the liquid phase from the solid phase;

(c) removal by evaporation of the residual solvent from the solid phase obtained in step (b);

(d) recovery by evaporation of the solvent from the liquid phase obtained in step (b).

The sediments used in the process according to the present invention typically consist of over 60% (with respect to the dry product) of particles with a particle-size lower than <63 μm and have a water content ranging from 20 to 70% by weight.

In step (a), the weight ratio sediment/solvent or solvent-cosolvent mixture ranges from 0.2 to 5.0, preferably from 0.5 to 1. This step is generally carried out at room temperature, for a time ranging from 10 to 120 minutes.

The solvents used in the process according to the present invention are selected so as to be non-toxic (a small part of them however remains in the sediment treated) and volatile (consequently easily removable from the sediment), inexpensive and easily available.

Examples of lipophile solvents suitable for the purposes of the present invention are ethyl acetate and petroleum ether. Among lipophile solvents, ethyl acetate is preferred for the purposes of the invention.

Examples of cosolvents suitable for the purposes of the present invention are selected from acetone and acetic acid. Acetone is preferably used.

Under the preferred conditions, the solvent is ethyl acetate and the cosolvent is acetone. The optimum solvent/cosolvent ratio is determined according to the method described in U.S. Pat. No. 5,585,002.

Steps (a) to (d) of the process according to the present invention can be repeated several times if necessary.

When a lipophile solvent is used, in step (b) of the process of the present invention, the separation of the liquid phase from the solid phase takes place instantly after the mixing has been stopped, due to the fact that the fine fraction of the sediment is kept agglomerated by the water and does not pass, except for a minimum part, into the extraction solvent.

In this way, a purified sediment from pollutants is obtained, consisting of both the coarse fraction and the fine fraction, and a liquid fraction (solvent) containing the pollutants.

When a solvent mixture is used, the solid/liquid separation according to step (b) can be effected using a hydrocyclone or a centrifuge. If the contamination of the sediment is limited only to the fine particles contained therein, a coarse fraction with a certain specification can be separated from a liquid phase containing the fine fraction; for this purpose, the separation of the coarse fraction from the liquid phase containing the fine fraction can be effected using an oscillating screen, and the separation of the fine fraction from the liquid phase can be subsequently carried out using a centrifuge or a hydrocyclone.

In step (c) of the process according to the present invention, the solid phase is heated to a temperature selected so as to allow the recovery of the residual extraction solvent, which can be recycled to step (a) of the process according to the present invention.

A temperature ranging from 60 to 100° C., preferably from 70 to 90° C. is preferably used.

The operation can be carried out using a rotating drum drier, a screen drier or other devices of the commercial type.

The recovery of the exhausted solvent (step d) can be effected using a fine film evaporator with scraped walls operating at atmospheric pressure or under slight depression. In this way, a boiler residue is obtained, containing the fraction extracted from the sediment and a fraction at the head consisting of the extraction solvent, which can be recycled to step (a) of the process according to the invention.

The process according to the present invention allows the toxicity of a sediment with high water contents and fine particles, to be reduced in a simple and economic way.

The following examples are provided for a better understanding of the invention and should not be considered as limiting its scope in any way.

### EXAMPLE 1

In the experimentation, a sediment polluted by chlorinated aromatic and aliphatic hydrocarbons is used, having the following characteristics:

70% of fine particles (fraction<63 μm);

61% of humidity;

total organic contaminants: 12786 mg/kg of dry product (determination by gaschromatography)

100 g of this sediment are introduced into a rotating cylinder together with 100 g of ethyl acetate and maintained under stirring, at room temperature, for 30 minutes.

After the mixture has been left to settle for 5 minutes, the liquid phase is filtered on a Teflon filter with 0.45 μm holes, in order to determine by weighing the fine fraction of the sediment entrained by the solvent.

The ethyl acetate is recovered from the liquid fraction by distillation in a rotating evaporator at 90° C.

96 g of solvent are recovered, which with the addition of 4 g of fresh ethyl acetate are used for a second washing cycle of the sediment.

The sediment recovered after extraction with the solvent is dried in the air for 24 hours and is then analyzed to determine the concentration of organic contaminants.

Table 1 indicates the residual concentration values of pollutant in the sediment after each washing cycle.

The last column on the right indicates the removal efficiencies (R) for each pollutant relating to the sediment discharged from the last cycle. The total removal efficiency for each cycle is indicated in the last line.

From the data specified in the table it can be observed that the treatment is capable of removing over 99% of the organic contaminants present in the sediment.

The total content of fine particles entrained by the solvent leaving each step is equal to 0.03% with respect to the solvent itself. This value is particularly important considering the predominant presence of fine material (<63 μm) in the sample treated.

The overall quantity of solvent recovered is equal to 96% of the initial quantity.

TABLE 1

| | as such | I step | II step | III step | R, III step |
|---|---|---|---|---|---|
| Compound | mg/kg in the dry sediment | | | | % |
| chloroethylene | 527 | ND | ND | ND | >99.9 |
| Tetrachloroethane | 224 | ND | ND | ND | >99.9 |
| Hexachloroethane | 582 | ND | ND | ND | >99.9 |
| Tetrachlorobutene iso | 195 | ND | ND | ND | >99.9 |
| Tetrachlorobutene iso | 205 | ND | ND | ND | >99.9 |
| Tetrachlorobutadiene | 992 | 4.8 | ND | ND | >99.9 |
| Pentachlorobutadiene iso | 243 | ND | ND | ND | >99.9 |
| Pentachlorobutadiene iso | 1689 | 6.1 | 2.9 | ND | >99.9 |
| Hexachlorobutadiene | 2340 | 14.0 | 7.5 | 4.1 | 99.8 |
| Pentachlorobutene iso | 746 | 4.1 | 5.8 | 3.9 | 99.5 |
| Pentachlorobutene iso | 4718 | 32.0 | 47.9 | 32.8 | 99.3 |
| Hexachlorobenzene | 325 | 12.1 | 19.8 | 13.9 | 95.7 |
| TOTAL | 12786 | 73.1 | 83.8 | 54.5 | 99.6 |
| Total removal (%) | — | 99.4 | 99.3 | 99.6 | |

ND: not determinable

### EXAMPLE 2

The same procedure is adopted as described in Example 1, with the difference that a 500 cc glass flask was used as mixing reactor together with a mechanical stirrer.

Table 2 indicates the removal results obtained with 4 extraction steps.

TABLE 2

| | |
|---|---|
| as such | IV step |

| | | |
|---|---|---|
| Compound | mg/kg | R % |

| | | | |
|---|---|---|---|
| Tetrachloroethylene | 527 | ND | >99.9 |
| Tetrachloroethane | 224 | ND | >99.9 |
| Hexachloroethane | 582 | ND | >99.9 |
| Tetrachlorobutene iso | 195 | 3.7 | >98.1 |
| Tetrachlorobutene iso | 205 | ND | >99.9 |
| Tetrachlorobutadiene | 992 | 13.0 | >98.7 |
| Pentachlorobutadiene iso | 243 | ND | >99.9 |
| Pentachlorobutadiene iso | 1689 | 18.6 | >98.9 |
| Hexachlorobutadiene | 2340 | 28.6 | 98.8 |
| Pentachlorobutene iso | 746 | 9.4 | 98.7 |
| Pentachlorobutene iso | 4718 | 63.3 | 98.7 |
| Hexachlorobenzene | 325 | 21.5 | 93.4 |
| TOTAL | 12786 | 157.9 | 98.8 |

ND: not determinable

The treatment is capable of removing over 98% of the organic contaminants present.

The total quantity of solvent recovered at the end of the extraction cycles proved to be 97% with respect to the quantity charged. The content of fine particles entrained is equal to 0.03%.

### EXAMPLE 3

500 g of sediment characterized by 70% of fine particles (fraction<63 μm) and 44% of humidity, polluted by aromatic polycyclic hydrocarbons, are put in contact with 500 g of a mixture of ethyl acetate and acetone in a ratio of 48/52, for 120 minutes, at room temperature. As a result of the contamination homogeneity of the sample, the separation of the coarse fraction (>63 μm) was not effected.

At the end of the first two extraction steps, the solid/liquid separation was carried out by decanting, after the subsequent 3 steps, it was effected by centrifugation at 700×g for 10 minutes.

Table 3 indicates the removal results obtained with 5 extraction steps.

TABLE 3

| | |
|---|---|
| as such | V step |

| | | |
|---|---|---|
| Compound | mg/kg | R % |

| | | | |
|---|---|---|---|
| Acenaphthene | 2.7 | <0.1 | >96 |
| Acenaphthylene | 1.8 | 0.2 | 89 |
| Anthracene | 4 | 0.1 | 98 |
| Benzo[a]anthracene | 1.6 | ND | >99 |
| Benzo[a]pyrene | 2.1 | ND | >99 |
| Benzo[b]fluoranthene + | 3 | ND | >99 |
| Benzo[k]fluoranthene | | | |
| Benzo[g,h,i]perylene | 2.1 | ND | >99 |
| Indeno[1,2,3,c,d]perylene | 1.2 | ND | >99 |
| Chrysene | 1.8 | ND | >99 |
| Dibenzo[a,h]anthracene | 0.2 | ND | >99 |
| Fluoranthene | 12.3 | 0.2 | 98 |
| Fluorene | 2.6 | <0.1 | >96 |
| Naphthalene | 87.5 | 0.7 | 99 |
| Phenanthrene | 12.3 | 0.2 | 98 |
| Pyrene | 15.9 | 0.2 | 99 |
| TOTAL | 151.1 | <1.8 | >99 |

ND = not determinable

The treatment is capable of removing over 99% of the organic contaminants present.

### EXAMPLE 4

An extraction test was effected as described in Example 3, with the difference that there were 8 extraction steps instead of 5. The results are indicated in Table 4.

TABLE 4

| | |
|---|---|
| as such | VIII step |

| | | |
|---|---|---|
| Compound | mg/kg | R % |

| | | | |
|---|---|---|---|
| Acenaphthene | 2.7 | <0.1 | >96 |
| Acenaphthylene | 1.8 | <0.1 | >94 |
| Anthracene | 4 | <0.1 | >98 |
| Benzo[a]anthracene | 1.6 | ND | >99 |
| Benzo[a]pyrene | 2.1 | ND | >99 |
| Benzo[b]fluoranthene + | 3 | ND | >99 |
| Benzo[k]fluoranthene | | | |
| Benzo[g,h,i]perylene | 2.1 | ND | >99 |
| Indeno[1,2,3,c,d]perylene | 1.2 | ND | >99 |
| Chrysene | 1.8 | ND | >99 |
| Dibenzo[a,h]anthracene | 0.2 | ND | >99 |
| Fluoranthene | 12.3 | <0.1 | >99 |
| Fluorene | 2.6 | ND | >99 |
| Naphthalene | 87.5 | 0.4 | >99 |
| Phenanthrene | 12.3 | 0.1 | 99 |
| Pyrene | 15.9 | <0.1 | >99 |
| TOTAL | 151.1 | <1.0 | >99 |

ND = not determinable

From the results indicated in the table, it can be observed that the treatment is capable of completely removing the organic contaminants.

1. A process for the removal of organic pollutants from sediments characterized by a water content ranging from 5% to the saturation limit of the sediment and with a prevalently fine particle-size content (<63 μm), comprising the following steps:
(a) mixing of said sediment with a lipophile solvent or with a mixture consisting of a lipophile solvent and a hydrophile cosolvent, said solvent and cosolvent being selected and mixed with each other in such a ratio as to form a single liquid phase with the water contained in the sediment;
(b) separation of the liquid phase from a solid phase;
(c) removal by evaporation of the residual solvent from the solid phase obtained in step (b);
(d) recovery by evaporation of the solvent from the liquid phase obtained in step (b).

2. The process according to claim 1, wherein the lipophile solvent is selected from petroleum ether and ethyl acetate.

3. The process according to claim 2, wherein the lipophile solvent is ethyl acetate.

4. The process according to claim 1, wherein the hydrophile cosolvent is selected from acetone and acetic acid.

5. The process according to claim 4, wherein the cosolvent is acetone.

6. The process according to claim 1, wherein the weight ratio between the sediment and the lipophile solvent or the mixture thereof with a hydrophile cosolvent ranges from 0.2 to 5.0.

7. The process according to claim 6, wherein the weight ratio between the sediment and the lipophile solvent or the mixture thereof with a hydrophile cosolvent ranges from 0.5 to 1.

8. The process according to claim 1, wherein in step (a) the mixing of the components is carried out at room temperature, for a time ranging from 10 to 60 minutes.

9. The process according to claim 1, wherein the separation in step (b) takes place by decanting when in step (a) the lipophile-solvent alone is used.

10. The process according to claim 1, wherein the separation in step (b) is carried out by means of a hydrocyclone or a centrifuge when in step (a) a solvent/cosolvent mixture is used.

11. The process according to claim 10, wherein step (b) is preceded by a step (b′) wherein a coarse fraction with a certain specification is separated by means of an oscillating screen from a liquid phase containing the fine fraction.

12. The process according to claim 1, wherein in step (c) the removal of the solvent from the solid fraction is carried out at a temperature ranging from 60 to 100° C.

13. The process according to claim 12, wherein the temperature ranges from 70 to 90° C.

14. The process according to claim 1, wherein step (c) is carried out by means of a rotating drum drier, a screen drier or other devices of the commercial type.

15. The process according to claim 1, wherein the recovery of the solvent in step (d) is carried out by means of a fine film evaporator with scraped walls operating at atmospheric pressure or under slight depression.

16. The process according to claim 1, wherein steps (a) to (d) can be repeated several times.

17. The process according to claim 1, wherein the solvent recovered in step (d) is recycled to step (a).

18. The process according to claim 1, wherein the organic pollutants are aliphatic and aromatic hydrocarbons, polynuclear aromatic hydrocarbons, aliphatic and aromatic organo-chlorinated products, pesticides, dioxins and dibenzofurans.
